(19) United States
(12) Patent Application Publication
(10) Pub. No.: US 2024/0103753 A1
(43) Pub. Date: Mar. 28, 2024

(54) GRAPHICAL USER INTERFACE OVERLAYS FOR CONTEXTUAL STORAGE CAPACITY INFORMATION

(71) Applicant: Dell Products L.P., Round Rock, TX (US)

(72) Inventors: Eric Graham, Austin, TX (US); Ashwini Paradkar, Austin, TX (US); Peace Iyiewuare, Austin, TX (US); Matthew Bryan Gilbert, Bend, OR (US); Peder Brooks Piggott, Pflugerville, TX (US); Mark Alan Herring, Pflugerville, TX (US)

(73) Assignee: Dell Products L.P., Round Rock, TX (US)

(21) Appl. No.: 17/935,369

(22) Filed: Sep. 26, 2022

(51) Int. Cl. G06F 3/06

(52) U.S. Cl. CPC G06F 3/0653; G06F 3/0608; G06F 3/0689

(57) ABSTRACT

A method for generating a graphical overlay indicating storage usage for a graphical representation of an information handling system includes determining a first storage capacity of a first hardware component of a second information handling system, determining a first storage usage of the first hardware component, generating a first graphical overlay for a first graphical representation of a physical configuration of the first information handling system based on the first storage capacity of the first hardware component and the first storage usage of the first hardware component, wherein the first graphical overlay comprises a first indication of the first storage usage of the first hardware component, and displaying the first graphical overlay and the first graphical representation.

### FIELD OF THE DISCLOSURE

The present disclosure generally relates to graphical user interfaces for information handling systems, and more particularly relates to graphical user interface overlays for contextual storage capacity information in information handling systems.

### BACKGROUND

As the value and use of information increase, individuals and businesses seek additional ways to process and store information. One option is an information handling system. An information handling system generally processes, compiles, stores, and/or communicates information or data for business, personal, or other purposes. Because technology and information handling needs may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems.

Information handling systems may include numerous hardware components having a variety of different forms and functions. Some information handling systems may include multiple slots, which may be hardware components themselves, for housing hardware components, such as hard disks, solid state drives, batteries, connectivity cards, dynamic RAM, and other components. A single information handling system may include up to hundreds, or more, hardware components. Hardware components of such information handling systems may be similar in appearance but may have different functions or capabilities. It may be difficult to determine details regarding a particular information handling system component simply by viewing the physical information handling system given the number and potentially similar appearance of hardware components contained in the information handling system. Furthermore, details regarding configuration of information handling system hardware components may not be readily apparent when viewing a physical exterior of an information handling system.

Shortcomings mentioned here are only representative and are included simply to highlight that a need exists for improved information handling systems. Embodiments described herein address certain shortcomings but not necessarily each and every one described here or known in the art. Furthermore, embodiments described herein may present other benefits than, and be used in other applications than, those of the shortcomings described above.

### SUMMARY

A first information handling system may generate a graphical representation of a physical configuration of a second information handling system, such as a graphical representation of a physical configuration of one or more hardware components of the second information handling system, based on a physical configuration of the components within the second information handling system. For example, the first information handling system may determine a form factor of components of an information handling system, such as hard disks, solid state drives, batteries, connectivity cards, and other information handling system components, and may determine a physical layout of the components within the second information handling system. Based on the physical configuration, such as the physical layout of the components or the form factor of the components, the first information handling system may generate a graphical representation of the physical configuration of the components within the second information handling system, such as by using pre-drawn graphics corresponding to each of the hardware components of the information handling system. For example, if the second information handling system includes a chassis with multiple slots, each slot capable of housing a component, the first information handling system may generate a graphical representation of the second information handling system showing the chassis, the slots, and any hardware components housed in the slots using a pre-drawn graphical representation of the chassis, the slots, and specific hardware components located in the slots. A user of the first information handling system may be able to view a visual representation of the second information handling system to determine the physical configuration of the second information handling system. Such a view may be particularly useful if the user of the first information handling system is monitoring or configuring the second information handling system remotely and is not present to view the physical second information handling system.

The graphical representation of the second information handling system may be further enhanced by providing one or more graphical overlays for the first graphical representation of the second information handling system generated based on component characteristics of the components of the second information handling system, such as a storage capacity of one or more hardware components, a storage usage of one or more hardware components, redundant array of independent disks (RAID) group membership of one or more hardware components, and other component characteristics. The graphical representation of the first information handling system or the overlays may be interactive, allowing a user to select hardware components or sets of hardware components to cause the first information handling system to display additional information regarding the second information handling system or to configure the components of the second information handling system. Such interactivity may enhance a user experience, providing a user with a visual representation of information that may otherwise only be available by examining the information handling system in person or by navigating through a complex series of text-based menus or tables, which may confuse a user due to a lack of easy identification of a physical configuration or characteristics of the information handling system and a lack of easy identification of hot spare devices. Furthermore, text-based menus or tables may lack a convenient way to determine redundant array of independent disks (RAID) group membership of specific components, which may cause users to physically reconfigure and move disks of a system to maintain ease of organization, such as adjacent positioning of hardware components that are members of a same RAID group. Such physical reconfiguration may be time consuming and may negatively impact a user experience. As another example, text-based menus or tables may create difficulties in visualizing the form factor of slots or components of an information handling system, as an information handling system may include multiple slots with different respective form factors. As another example, it may be difficult for a user to determine, using a text-based menu, remaining storage capacity of specific hardware components or to determine a specific physical hardware component that has reached its physical capacity. A graphical overlay for a representation of a physical configuration of a second information handling system showing storage capacity, usage, and availability may allow a user to, at a glance, determine one or more drives at or approaching full storage usage. Such an overlay may allow for more efficient storage planning. Furthermore, in certain circumstances, such as when a passthrough mode is activated, users must rely on third party programs to determine storage usage, which may be difficult to navigate.

Graphical overlays for a graphical representation of an information handling system's physical configuration may provide a user with additional contextual information regarding used and available storage capacity of hardware components of an information handling system. A method may begin with determining a first storage capacity of a first hardware component of an information handling system. Such a method may be performed by a first information handling system, and the information handling system including the first hardware component may be a second information handling system. In some embodiments, the second information handling system may be the first information handling system, while in other embodiments the second information handling system may be different from the first information handling system. For example, the first storage capacity may be determined by a first information handling system by receiving the component characteristics from the second information handling system. Alternatively or additionally, component characteristics, such as storage capacity and storage usage, may be determined by the second information handling system by querying one or more hardware components of the second information handling system for component characteristics, such as storage capacity and storage usage. Component characteristics may, for example, include slots in which specific hardware components are located, redundant array of independent disk (RAID) group membership of specific hardware components, hot spare statuses of specific hardware components, bay location of the specific hardware components, compute express link (CXL) capability or status of the specific hardware components, storage capacities of specific hardware components, and storage usages of specific hardware components. Component characteristics may, in some embodiments, include information regarding a physical configuration of the hardware components. In some embodiments the first information handling system may determine storage capacities of other components of the second information handling system, such as a second storage capacity of a second hardware component.

The first information handling system may determine a first storage usage of the first hardware component. For example, the first information handling system may determine an amount of a storage volume of the first hardware component that is currently used for storing information or that is currently allocated for storing information. In some embodiments, the first information handling system may determine storage usages of multiple hardware components, such as a second storage usage of a second hardware component of the second information handling system.

In some embodiments, the first information handling system may determine a physical configuration of the second information handling system, such as positioning of one or more hardware components within a chassis of the second information handling system or a form factor of the one or more hardware components and may generate a first graphical representation of the physical configuration of the second information handling system based on the determined physical configuration. For example, the first information handling system may determine a form factor of components of the second information handling system, such as a form factor of a chassis of the second information handling system or a form factor of one or more components housed within the chassis of the second information handling system based on component characteristics identifying the components of the second information handling system. The first information handling system may further determine a location of each component within the second information handling system, such as a slot in which each component is located or other location information. Based on the determined physical configuration, the first information handling system may generate a first graphical representation of the components of the second information handling system, such as an image of the second information handling system including the components of the second information handling system. Such an image may, for example, be a scalable vector graphics (SVG) image of the first information handling system.

The first information handling system may generate a first graphical overlay for a first graphical representation of the first information handling system based on the first storage capacity of the first hardware component and the first storage usage of the first hardware component. The first graphical overlay may, for example, comprise a first indication of the first storage usage of the first hardware component. In some embodiments, the first graphical overlay may be generated further based on the second storage capacity and second storage usage of a second hardware component of the second information handling system. For example, the first graphical overlay may include a second indication of the second storage usage of the second hardware component. In some embodiments, a first graphical overlay may include graphical indications of storage usages of multiple hardware components, to allow a user to determine storage usage of multiple hardware components at a glance.

The first information handling system may display the first graphical overlay and the first graphical representation. For example, the first information handling system may overlay the first graphical overlay on the first graphical representation to indicate storage usage of one or more hardware components of the second information handling system. In some embodiments, displaying the first graphical overlay and the first graphical representation may be transmitting an instruction to display the first graphical overlay and the first graphical representation to another information handling system.

In some embodiments, an information handling system may generate multiple graphical overlays, such as graphical overlays for showing storage usage of hardware components that belong to specific RAID groups. The first information may, for example, determine that the first hardware component and the second hardware component belong to a first RAID group. Such a determination may, for example, be made based on component characteristics of the first hardware component and the second hardware component. The first information handling system may generate a second graphical overlay for the first graphical representation based on the determination that the first hardware component and the second hardware component belong to the first RAID group. The second graphical overlay may include a third indication of the first RAID group. For example, the second graphical overlay may indicate that the first hardware component and the second hardware component are both members of the first RAID group. As one particular example, the second graphical overlay may indicate storage usages of hardware components that are members of the first RAID group but may not indicate storage usages of hardware components that are not members of the first RAID group.

In some embodiments, the graphical representations or overlays may be interactive. For example, the first information handling system may receive a selection of a second graphical representation of the first hardware component. The second graphical representation may, in some embodiments, be a part of the first graphical representation. The selection may, for example, be input from a user such as placement of a cursor on the second graphical representation, clicking of the second graphical representation, or other selection of the second graphical representation. The first information handling system may determine that a RAID group view is selected and may display the second graphical overlay, including the third indication of the first RAID group, and the first graphical representation based on the received selection. Such an overlay may be used to provide the user with additional information about the first RAID group.

As another example, the first information handling system may receive the selection of the second graphical representation of the first hardware component and may determine that a hardware component view is selected. The first information handling system may then generate a second graphical overlay for the first graphical representation that includes a second indication of one or more characteristics of the first hardware component and may display the second graphical overlay and the first graphical representation based on the received selection. Such an overlay may be used to provide the user with additional information about a specific hardware component.

In some embodiments, the first graphical overlay may indicate wasted storage in one or more hardware components that are members of RAID groups. For example, a maximum amount of storage that can be used on each member of a RAID group may be equal to a storage capacity of a member of the RAID group with the lowest storage capacity. Thus, members of a RAID group that have higher storage capacity than the member of the RAID group with the lowest storage capacity may each have an amount of wasted storage equal to the difference between a storage capacity of each respective hardware component and the storage capacity of the hardware component with the lowest storage capacity. The first information handling system may determine that the first hardware component and the second hardware component belong to a first RAID group. The first information handling system may determine that the storage capacity of the second hardware component is lower than the storage capacity of the first hardware component. In some embodiments, the first information handling system may determine that the storage capacity of the second hardware component is the lowest storage capacity of all the hardware components that belong to the first RAID group. The first information handling system may determine an amount of wasted storage of the first hardware component based on the second storage capacity of the second hardware component and the first storage capacity of the first hardware component. For example, the first information handling system may determine a difference between the first storage capacity of the first hardware component and the second storage capacity of the second hardware component. Generation of the first graphical overlay may include generating a third indication of the wasted storage of the first hardware component, and the first graphical overlay may include the third indication. In some embodiments, the first graphical overlay may include indications of wasted storage on each hardware component that includes wasted storage.

In some embodiments, an information handling system may include a memory and a processor for performing the methods described herein. A computer program product may include a non-transitory computer-readable medium including instructions for causing an information handling system to perform the method described herein.

The foregoing has outlined rather broadly certain features and technical advantages of embodiments of the present invention in order that the detailed description that follows may be better understood. Additional features and advantages will be described hereinafter that form the subject of the claims of the invention. It should be appreciated by those having ordinary skill in the art that the conception and specific embodiment disclosed may be readily utilized as a basis for modifying or designing other structures for carrying out the same or similar purposes. It should also be realized by those having ordinary skill in the art that such equivalent constructions do not depart from the spirit and scope of the invention as set forth in the appended claims. Additional features will be better understood from the following description when considered in connection with the accompanying figures. It is to be expressly understood, however, that each of the figures is provided for the purpose of illustration and description only and is not intended to limit the present invention.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a layout of an example information handling system according to some embodiments of the disclosure.

FIG. 2 is an example table-based user interface of an information handling system according to some embodiments of the disclosure.

FIG. 3 is an example graphical representation of an information handling system according to some embodiments of the disclosure.

FIG. 4A is an example graphical representation of an information handling system with an overlay indicating storage usage and capacity for hardware components of the information handling system according to some embodiments of the disclosure.

FIG. 4B is an example graphical representation of a hardware component with an overlay indicating storage usage and capacity for the hardware component according to some embodiments of the disclosure.

FIG. 5 is an example graphical representation of an information handling system with an overlay indicating storage usage, capacity, and other component information for hardware components of the information handling system according to some embodiments of the disclosure.

FIG. 6 is an example graphical representation of an information handling system with an overlay indicating storage capacity and usage of hardware components that are members of a first RAID group according to some embodiments of the disclosure.

FIG. 7 is a flow chart of an example method for generation of graphical representations of information handling system components and overlays according to some embodiments of the disclosure.

FIG. 8 is a flow chart of an example method for generation of graphical representations of information handling system components and overlays according to some embodiments of the disclosure.

FIG. 9 is a flow chart of an example method for generation of graphical representations of information handling system components and overlays according to some embodiments of the disclosure.

FIG. 10 is a flow chart of an example method for generation of graphical representations of information handling system components and overlays according to some embodiments of the disclosure.

FIG. 11 is an example system for generation of graphical representations of physical configurations of information handling system hardware components and overlays according to some embodiments of the disclosure.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other teachings can certainly be used in this application. The teachings can also be used in other applications and with several different types of architectures.

For purposes of this disclosure, an information handling system (IHS) may include any instrumentality or aggregate of instrumentalities operable to compute, determine, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, a two-in-one laptop/tablet computer, handheld gaming system, console gaming system, hybrid gaming system, mobile device (e.g., personal digital assistant (PDA), smart phone, tablet computer, or smart watch), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more virtual or physical buses operable to transmit communications between the various hardware and/or software components.

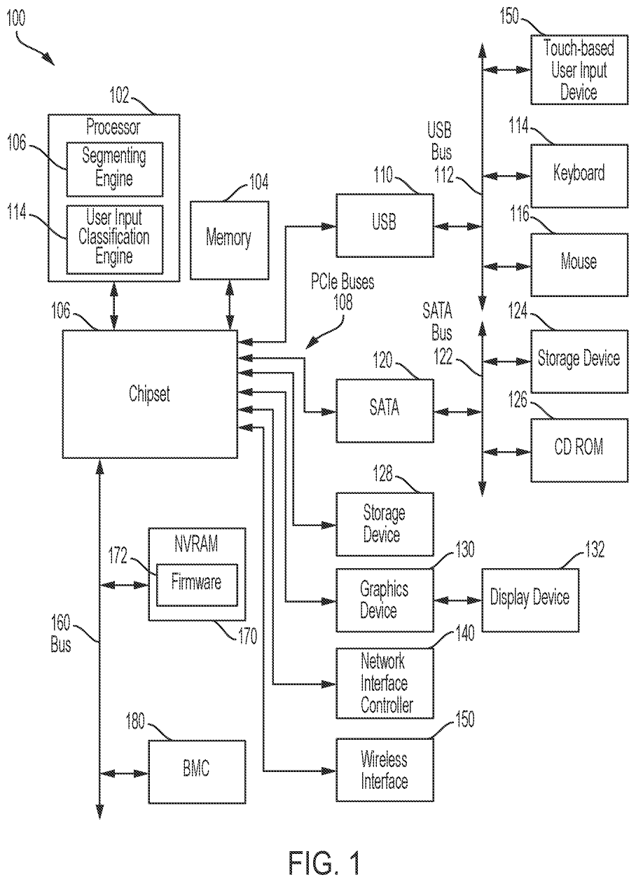

FIG. 1 illustrates an example information handling system 100. Information handling system 100 may include a processor 102 (e.g., a central processing unit (CPU)), a memory (e.g., a dynamic random-access memory (DRAM)) 104, and a chipset 106. In some embodiments, one or more of the processor 102, the memory 104, and the chipset 106 may be included on a motherboard (also referred to as a mainboard), which is a printed circuit board (PCB) with embedded conductors organized as transmission lines between the processor 102, the memory 104, the chipset 106, and/or other components of the information handling system. The components may be coupled to the motherboard through packaging connections such as a pin grid array (PGA), ball grid array (BGA), land grid array (LGA), surface-mount technology, and/or through-hole technology. In some embodiments, one or more of the processor 102, the memory 104, the chipset 106, and/or other components may be organized as a System on Chip (SoC).

The processor 102 may execute program code by accessing instructions loaded into memory 104 from a storage device, executing the instructions to operate on data also loaded into memory 104 from a storage device, and generate output data that is stored back into memory 104 or sent to another component. The processor 102 may include processing cores capable of implementing any of a variety of instruction set architectures (ISAs), such as the x86, POWERPC®, ARM®, SPARC®, or MIPS® ISAs, or any other suitable ISA. In multi-processor systems, each of the processors 102 may commonly, but not necessarily, implement the same ISA. In some embodiments, multiple processors may each have different configurations such as when multiple processors are present in a big-little hybrid configuration with some high-performance processing cores and some high-efficiency processing cores. The chipset 106 may facilitate the transfer of data between the processor 102, the memory 104, and other components. In some embodiments, chipset 106 may include two or more integrated circuits (ICs), such as a northbridge controller coupled to the processor 102, the memory 104, and a southbridge controller, with the southbridge controller coupled to the other components such as USB 110, SATA 120, and PCIe buses 108. The chipset 106 may couple to other components through one or more PCIe buses 108.

Some components may be coupled to one bus line of the PCIe buses 108, whereas some components may be coupled to more than one bus line of the PCIe buses 108. One example component is a universal serial bus (USB) controller 110, which interfaces the chipset 106 to a USB bus 112. A USB bus 112 may couple input/output components such as a keyboard 114 and a mouse 116, but also other components such as USB flash drives, or another information handling system. Another example component is a SATA bus controller 120, which couples the chipset 106 to a SATA bus 122. The SATA bus 122 may facilitate efficient transfer of data between the chipset 106 and components coupled to the chipset 106 and a storage device 124 (e.g., a hard disk drive (HDD) or solid-state disk drive (SDD)) and/or a compact disc read-only memory (CD-ROM) 126. The PCIe bus 108 may also couple the chipset 106 directly to a storage device 128 (e.g., a solid-state disk drive (SDD)). A further example of an example component is a graphics device 130 (e.g., a graphics processing unit (GPU)) for generating output to a display device 132, a network interface controller (NIC) 140, and/or a wireless interface 150 (e.g., a wireless local area network (WLAN) or wireless wide area network (WWAN) device) such as a Wi-Fi® network interface, a Bluetooth® network interface, a GSM® network interface, a 3G network interface, a 4G LTE® network interface, and/or a 5G NR network interface (including sub-6 GHz and/or mmWave interfaces).

The chipset 106 may also be coupled to a serial peripheral interface (SPI) and/or Inter-Integrated Circuit (I2C) bus 160, which couples the chipset 106 to system management components. For example, a non-volatile random-access memory (NVRAM) 170 for storing firmware 172 may be coupled to the bus 160. As another example, a controller, such as a baseboard management controller (BMC) 180, may be coupled to the chipset 106 through the bus 160. BMC 180 may be referred to as a service processor or embedded controller (EC). Capabilities and functions provided by BMC 180 may vary considerably based on the type of information handling system. For example, the term baseboard management system may be used to describe an embedded processor included at a server, while an embedded controller may be found in a consumer-level device. As disclosed herein, BMC 180 represents a processing device different from processor 102, which provides various management functions for information handling system 100. For example, an embedded controller may be responsible for power management, cooling management, and the like. An embedded controller included at a data storage system may be referred to as a storage enclosure processor or a chassis processor.

System 100 may include additional processors that are configured to provide localized or specific control functions, such as a battery management controller. Bus 160 can include one or more busses, including a Serial Peripheral Interface (SPI) bus, an Inter-Integrated Circuit (I2C) bus, a system management bus (SMBUS), a power management bus (PMBUS), or the like. BMC 180 may be configured to provide out-of-band access to devices at information handling system 100. Out-of-band access in the context of the bus 160 may refer to operations performed prior to execution of firmware 172 by processor 102 to initialize operation of system 100.

Firmware 172 may include instructions executable by processor 102 to initialize and test the hardware components of system 100. For example, the instructions may cause the processor 102 to execute a power-on self-test (POST). The instructions may further cause the processor 102 to load a boot loader or an operating system (OS) from a mass storage device. Firmware 172 additionally may provide an abstraction layer for the hardware, such as a consistent way for application programs and operating systems to interact with the keyboard, display, and other input/output devices. When power is first applied to information handling system 100, the system may begin a sequence of initialization procedures, such as a boot procedure or a secure boot procedure. During the initialization sequence, also referred to as a boot sequence, components of system 100 may be configured and enabled for operation and device drivers may be installed. Device drivers may provide an interface through which other components of the system 100 can communicate with a corresponding device. The firmware 172 may include a basic input-output system (BIOS) and/or include a unified extensible firmware interface (UEFI). Firmware 172 may also include one or more firmware modules of the information handling system. Additionally, configuration settings for the firmware 172 and firmware of the information handling system 100 may be stored in the NVRAM 170. NVRAM 170 may, for example, be a non-volatile firmware memory of the information handling system 100 and may store a firmware memory map namespace 100 of the information handling system. NVRAM 170 may further store one or more container-specific firmware memory map namespaces for one or more containers concurrently executed by the information handling system.

Information handling system 100 may include additional components and additional busses, not shown for clarity. For example, system 100 may include multiple processor cores (either within processor 102 or separately coupled to the chipset 106 or through the PCIe buses 108), audio devices (such as may be coupled to the chipset 106 through one of the PCIe busses 108), or the like. While a particular arrangement of bus technologies and interconnections is illustrated for the purpose of example, one of skill will appreciate that the techniques disclosed herein are applicable to other system architectures. System 100 may include multiple processors and/or redundant bus controllers. In some embodiments, one or more components may be integrated together in an integrated circuit (IC), which is circuitry built on a common substrate. For example, portions of chipset 106 can be integrated within processor 102. Additional components of information handling system 100 may include one or more storage devices that may store machine-executable code, one or more communications ports for communicating with external devices, and various input and output (I/O) devices, such as a keyboard, a mouse, and a video display.

In some embodiments, processor 102 may include multiple processors, such as multiple processing cores for parallel processing by the information handling system 100. For example, the information handling system 100 may include a server comprising multiple processors for parallel processing. In some embodiments, the information handling system 100 may support virtual machine (VM) operation, with multiple virtualized instances of one or more operating systems executed in parallel by the information handling system 100. For example, resources, such as processors or processing cores of the information handling system may be assigned to multiple containerized instances of one or more operating systems of the information handling system 100 executed in parallel. A container may, for example, be a virtual machine executed by the information handling system 100 for execution of an instance of an operating system by the information handling system 100. Thus, for example, multiple users may remotely connect to the information handling system 100, such as in a cloud computing configuration, to utilize resources of the information handling system 100, such as memory, processors, and other hardware, firmware, and software capabilities of the information handling system 100. Parallel execution of multiple containers by the information handling system 100 may allow the information handling system 100 to execute tasks for multiple users in parallel secure virtual environments.

An information handling system may include multiple hardware components, such as SSDs, hard disks, connectivity cards, graphics processing units (GPUs), batteries, field programmable gate arrays (FPGAs), and other hardware components. In some embodiments, an information handling system may include multiple slots for housing hardware components, and in some embodiments, an information handling system may house more than one hundred components. Hardware components of an information handling system may also include a chassis of an information handling system, one or more bays of an information handling system, or one or more slots of an information handling system. Information handling systems may include bays, which may include one or more slots. In some embodiments, different bays, slots located in the different bays, may have different capabilities. For example, some slots of an information handling system or hardware components located in slots of an information handling system may have different form factors, may belong to different storage domains, and may support different technology types. As one example, some slots or hardware components may support series attached small computer system interface (SAS) storage and connectivity and may have a first form factor, while other slots or hardware components may support M.2 storage and connectivity and may have a second, different, form factor. As another example, some bays, and slots located therein, may support CXL, while other bays or slots may not. Enabling or disabling CXL functionality in a bay that supports CXL may, in table-based GUIs, require navigation through a complex series of prompts and menus. In some cases, information handling systems may have multiple hardware components, such as slots, labeled with a same number, such as 0 or 1, and hardware components sharing a same number may even be located on a same visual plane. As another example, backplanes of an information handling system may include bays that have 40, 24, 8, 4 or another number of slots. Some information handling systems may not include physical dividers, such as sheet metal dividers, indicating where one bay, with slots having a first set of capabilities, ends and another bay, with slots having a second set of capabilities, begins. Some information handling systems may support enterprise and data center solid state drive form factor (EDSFF), and may include hardware components with a same or similar form factor, but different functions, such as dynamic random access memory (DRAM) hardware components, FPGA hardware components, general purpose GPU (GPGPU) hardware components, and other hardware components. Furthermore, slots and bays that house EDSFF hardware components may be updated over time, such as through firmware updates, and may thus have different capabilities depending on an update status of each individual slot or bay. Viewing a physical front of an information handling system may not provide sufficient information to a user of the information handling system regarding hardware component status or functionality. For example, viewing a physical front of an information handling system may not allow a user to determine capabilities or firmware update status of bays or slots of an information handling system. Furthermore, packaging of an information handling system may not provide up to date information regarding capabilities of bays or slots of the information handling system due to firmware updates performed after printing of the packaging. As another example, viewing a physical information handling system, packaging, or user interface may not provide a user with information regarding whether a backplane or one or more bays of the information handling system supports one or more upgrades, such as an upgrade to a faster bus speed (e.g., an upgrade from SAS to nonvolatile memory express (NVMe)).

Information handling systems may have multiple storage hardware components, such as multiple solid state drives, multiple hard drives, and other hardware storage components. A storage capacity and storage usage of each hardware component may not be determinable by viewing an exterior of a physical information handling system. For example, a user may be required to navigate a series of text-based tables or menus to determine storage capacity and usage of hardware components of an information handling system. It may be difficult for a user, using such tables and menus, to determine which physical component listed storage capacity or usage information corresponds to. Furthermore, it may be difficult for a user to determine an amount of wasted storage present on one or more hardware components due to membership of the hardware components in a RAID group.

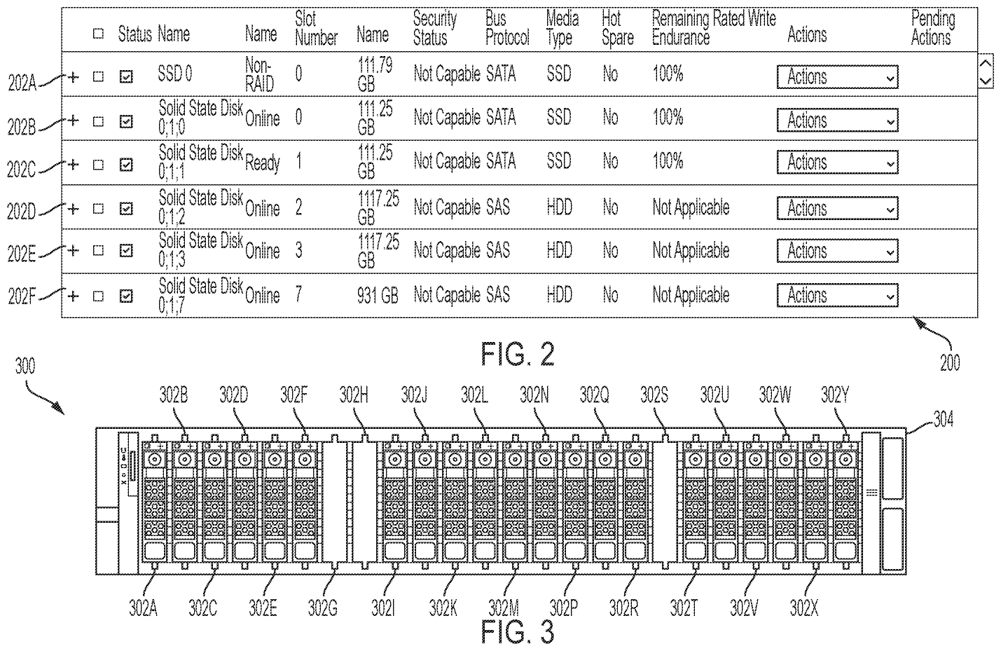

An example table-based user interface 200 is shown in FIG. 2. The user interface 200 may be a table with multiple entries 202A-F providing information about hardware components of an information handling system. For example, entry 202A may provide information regarding a first solid state drive, entry 202B may provide information regarding a first solid state disk, entry 202C may provide information regarding a second solid state disk, entry 202D may provide information regarding a first physical disk, entry 202E may provide information regarding a second physical disk, and entry 202F may provide information regarding a third physical disk. The user interface 200 may include information such as a status of each hardware component, a name of each hardware component, a state of each hardware component, a slot number in which each hardware component is located, a storage capacity or size of each hardware component, a security status of each hardware component, bus protocol of each hardware component, a media type of each hardware component, a hot spare status of each hardware component, a remaining rated write endurance of each hardware component, and pending actions for each hardware component. Such information elements may, for example, be component characteristics of the respective hardware components. As shown in the user interface 200, multiple components may share a same slot number, and the shared slot number may make it difficult for a user to determine a physical configuration of the hardware components using the table-based user interface 200. Furthermore, the table-based user interface 200 may not provide information regarding bay location or RAID membership of the hardware components in a same view as the information shown in the user interface 200 of FIG. 2. The table-based user interface 200 may provide hot spare status, as shown in FIG. 2, but may not provide a user with information regarding whether a hot spare is assigned to one or more specific RAIDs of the information handling system or to the information handling system in general or information regarding whether there is a hot spare available in a same view with the information shown in FIG. 2. If a table-based user interface 200 does include information regarding bays of an information handling system, and bay capabilities, determining such information may require a user to navigate a complicated table, that may include information for up to 40 or more slots having five or more different technology types and capabilities. The user interface 200 may also provide actions to allow a user to select one or more changes to a configuration of each of the hardware components. However, a user may be unaware of a context of each of the hardware components given the lack of information regarding positioning of the components within the information handling system or RAID membership of each of the hardware components. Furthermore, selection of an action may require a user to select multiple options, navigating through a complex set of menus to change a configuration of a component.

Generation and display of a graphical representation of a physical configuration of an information handling system, such as a graphical representation of a physical configuration of hardware components of the information handling system, may provide a user with additional contextual information regarding the information handling system enhancing a user experience and reducing user error when adjusting configuration of the information handling system. An example graphical user interface 300 including a graphical representation 304 of a physical configuration of an information handling system is shown in FIG. 3. The graphical representation 304 of the information handling system may include graphical representations 302A-Y of a plurality of hardware components of the information handling system, such as a plurality of hardware components housed in slots or a plurality of slots. For example, the graphical representation 304 of the information handling system may include graphical representations 302A-F, I-R, and T-Y of hardware components housed in slots of the information handling system. The graphical representation 304 may further include graphical representations 302G-H, S of empty slots that do not currently house other hardware components. The graphical representation 304 may be generated using information retrieved from the information handling system including the components shown in graphical representations 302A-Y. For example, the graphical representation 304 may be updated when a component is removed or changed to reflect the change. As one example, when generating the graphical representation 300, an information handling system may query one or more hardware components, such as a backplane of the information handling system, one or more bays of the information handling system, or the one or more hardware components, such as controllers of the one or more hardware components, shown in graphical representations 302A-Y, to determine a physical configuration of the one or more hardware components, such as which hardware components are housed in which slots of the information handling system. In some embodiments, the first information handling system may query an enclosure of the second information handling system to determine component characteristics. The physical configuration may, for example, be determined based on component characteristics received from the hardware components, such as a form factor of the hardware components, a function of the hardware components, a location of the hardware components within the information handling system, and other component characteristics. In some embodiments, the information handling system shown in the graphical representation 304 may generate the graphical representation. In some embodiments, the information handling system shown in the graphical representation 304 may provide information regarding the physical configuration of the information handling system, such as component characteristics of the hardware components, to a different information handling system, and the different information handling system may generate or display the graphical representation 304. For example, the graphical representation 304 may be displayed on a display of a remote tablet, laptop, smart phone, or other information handling system, or may be displayed on a display of the information handling system of the graphical representation 304. The graphical representation 304 may provide a user with additional context regarding information handling system component physical configuration not present in the table-based graphical user interface of FIG. 2. For example, a user may, at a glance, determine which slots of the information handling system house hardware components and which are empty. In some embodiments, a user may determine which hardware components are located in which slots of the information handling system. As another example, a remote user of a second information handling system may view the graphical representation 304 to determine a location of a particular component to be adjusted and may communicate with an on-site user using the reference of the graphical representation 304 reflecting the physical configuration viewed by the on-site user.

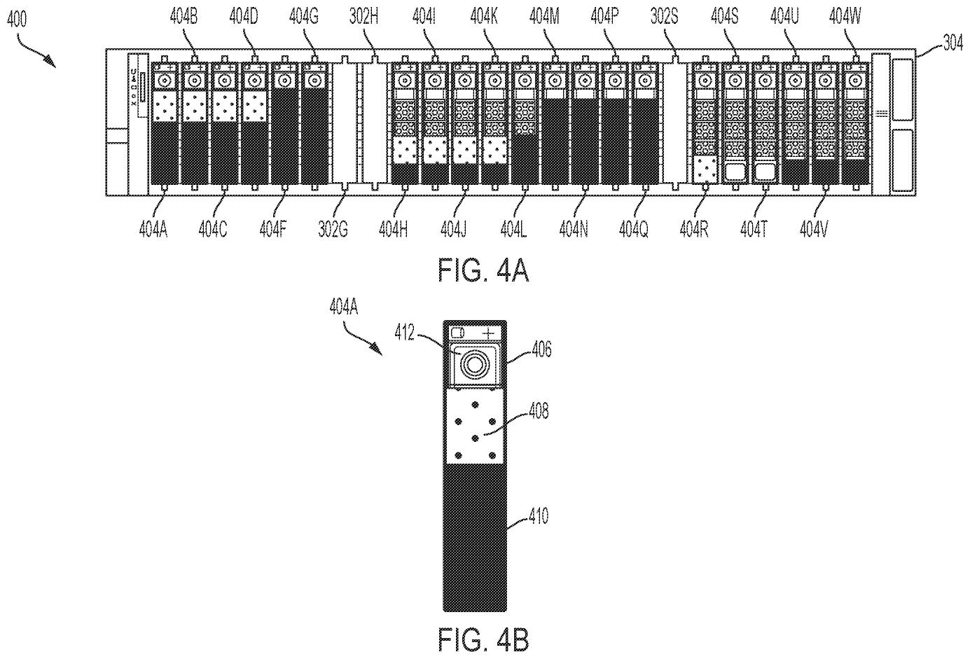

Generation and display of overlays for a graphical representation of a physical configuration of an information handling system may provide a user with additional contextual information regarding the information handling system and the hardware components of the information handling system. Such additional information may enhance a user experience, allowing the user to determine information regarding the information handling system quickly without requiring navigation of an extensive series of menus. An example graphical user interface 400 including an overlay displayed along with a graphical representation 304 of an information handling system is shown in FIG. 4A. The graphical user interface 400 including the overlay may provide a user with information regarding storage capacity, storage usage, and wasted storage on each of multiple hardware components of the information handling system. The first graphical overlay may include overlay components 404A-W that may each overlay a graphical representation of a hardware component. Some graphical representations of hardware components, such as graphical representations 302G-H, S of empty slots, may not be overlaid by overlay components. For example, empty slots may not have a storage capacity and may thus not be overlaid with a graphical indication of a storage capacity, usage, or wasted storage. Overlay components 404A-W may each overlay a graphical representation of a hardware component and may each indicate a storage capacity, storage usage, or wasted storage of the overlaid hardware component.

For example, FIG. 4B shows an example graphical overlay component 404A over a graphical representation 412 of a first hardware component. The graphical overlay component 404A may include a border 406 indicating the graphical representation 412 of the hardware component and a first indication 410 indicating an amount of storage of the hardware component currently in use. For example, the first indication 410 may indicate a percentage of the storage capacity of the hardware component that is currently in use by filling a corresponding portion of the area within the border 406. Generation of such an overlay component 404A may, for example, include determining a first storage capacity of the hardware component represented by the graphical representation 412 and determining a first storage usage of the hardware component represented by the graphical representation 412. The storage capacity and the storage usage of the hardware component may, for example, be component characteristics of the hardware component and may be determined by querying a controller of the hardware component. Based on the storage capacity and the storage usage of the hardware component, the graphical overlay component 404A may be generated. In some embodiments, a first overlay may include multiple overlay components such as shown in FIG. 4A. For example, an information handling system may determine storage capacities and usages for multiple hardware components and may generate overlay components 404A-W for each of the multiple hardware components. Thus, a user may determine a storage usage of multiple hardware components by viewing the first graphical representation and the first overlay.

In some embodiments, indications of amounts of wasted storage on hardware components may also be included in the first graphical overlay. The graphical overlay component 404A of FIG. 4B may include a second indication 408 of an amount of wasted storage of the hardware component represented by graphical representation 412. Wasted storage may be present on hardware components that are members of a RAID group but have a storage capacity greater than a member of the RAID group with the lowest storage capacity. In some embodiments, usage of storage on hardware components that are members of a RAID group may be limited to no more than a storage capacity of a member of the RAID group with a lowest storage capacity. For example, an information handling system may determine storage capacities of each member of a RAID group and may determine a lowest storage capacity of a member of the RAID group. The information handling system may then determine an amount of wasted storage on each member of the RAID group that has a storage capacity greater than the lowest storage capacity by determining the difference between the storage capacity of the respective member and the lowest storage capacity of the RAID group. Thus, the hardware component represented by the graphical representation 412 may be a member of a first RAID group and may have a greater storage capacity than another member of the RAID group. The wasted storage on the hardware component may be represented by the second indication 408 of the graphical overlay component 404A. Such a determination may be performed for multiple members of multiple RAID groups in generating the first graphical overlay of FIG. 4A. For example, graphical overlay components 404A-D, H-K, and R of FIG. 4A may each include indications of amounts of wasted storage of their respective hardware components. Thus, a first overlay for a graphical representation of a physical configuration of an information handling system may include multiple overlay components 404A-W which may indicate a storage usage or wasted storage of multiple hardware components of the second information handling system.

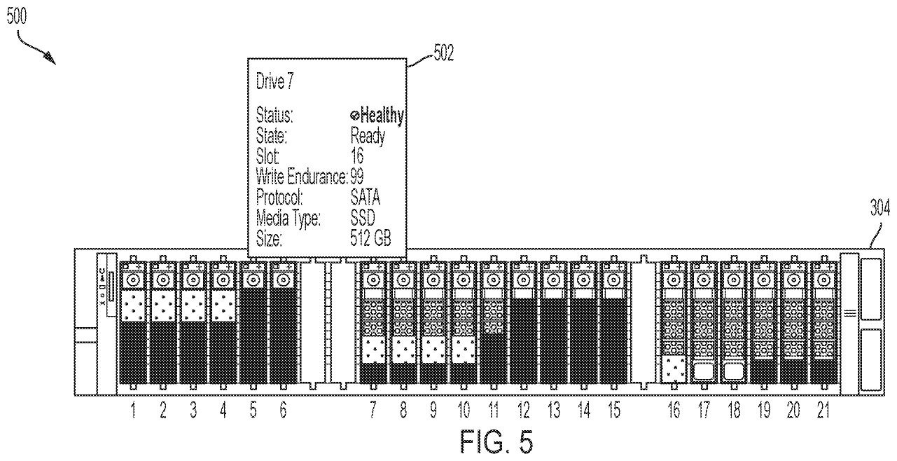

A graphical user interface may allow a user to select a view for viewing graphical overlays on a graphical representation of a physical configuration of an information handling system. Such views may include a hardware component view and a RAID group view. Such views may, for example, allow interactivity, allowing a user to view additional graphical overlays or graphical overlay components based on selections made by a user. An example graphical user interface 500 including the first graphical representation 304 of the physical configuration of the information handling system and a second graphical overlay for a hardware component view when a graphical representation of a first hardware component is selected by a user is shown in FIG. 5. The second graphical overlay of FIG. 5 may include some or all of the overlay components 404A-W of FIG. 4A with the addition of a window 502 displaying additional component characteristics of the selected hardware component. For example, the graphical user interface 400 of FIG. 4A may be displayed for a user, and when the user selects a graphical representation of a hardware component, such as the graphical representation beneath the graphical overlay component 404H, the user may be presented with the graphical overlay of FIG. 5. Such selection may include hovering of a cursor over the graphical representation of the hardware component, clicking on the graphical representation of the hardware component, or otherwise selecting the graphical representation of the hardware component. In some embodiments, the graphical overlay of FIG. 5 may be generated upon selection of a graphical representation of a hardware component, while in other embodiments graphical overlays for each hardware component may be generated in advance and displayed when a graphical representation of a corresponding hardware component is selected. The window 502 of the second graphical overlay may include information about the hardware component such as a name of the hardware component, a status of the hardware component, a state of the hardware component, a slot in which the hardware component is located, a write endurance of the hardware component, a protocol of the hardware component, a media type of the hardware component, and a size of the hardware component. In some embodiments, the graphical representation 304 of the information handling system may include numbering for each slot of the information handling system to enable a user to easily determine a slot number of a graphical representation of a hardware component. Thus, a second graphical overlay including a window 502 may be displayed for a user when the user selects a graphical representation of a specific hardware component and when a hardware component view is selected.

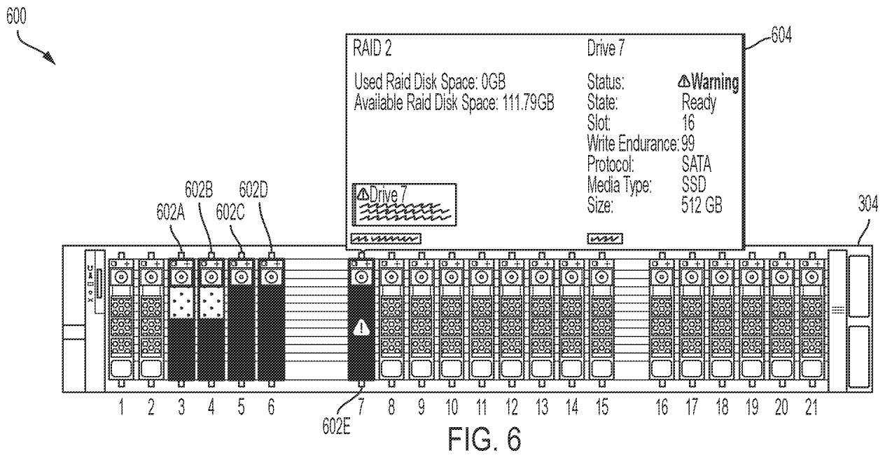

An example graphical user interface 600 including the first graphical representation 304 of the physical configuration of the information handling system and a second graphical overlay for a RAID group view when a graphical representation of a first hardware component that is a member of a first RAID group is selected by a user is shown in FIG. 6.

The second graphical overlay of FIG. 6 may include some of the overlay components 404A-W of FIG. 4A, such as overlay components 404C-H with the addition of a window 604 presenting additional component characteristics of the selected hardware component and RAID group. For example, overlay components 602A-E may each overlay graphical representations of hardware components that are members of a first RAID group. When a user selects the graphical representation 404H of a hardware component of the graphical user interface 400 of FIG. 4, such as by hovering a mouse cursor over or clicking on the graphical representation 404H, if a RAID group view is selected an information handling system may determine that hardware components, the graphical representations of which are overlaid by overlay components 404C-H, are members of the first RAID group and may display the second graphical overlay including overlay components 602A-E and 604. In some embodiments, graphical overlays for various RAID groups may be generated in advance, while in other embodiments a graphical overlay for a first RAID group may be generated when a graphical representation of a component that is a member of the first RAID group is selected. The graphical overlay of FIG. 6 may enable a user to easily determine which hardware components are members of the first RAID group and storage usage, capacity, and wasted storage of each of the hardware components that is a member of the first RAID group. The hardware components having graphical representations overlaid by overlay components 602C-E may each have an equivalent level of storage capacity, while a storage capacity of the hardware components having graphical representations overlaid by overlay components 602A-B may be greater than the storage capacity of the hardware components having graphical representations overlaid by overlay components 602C-E. Thus, the overlay components 602A-B may indicate wasted storage in their respective hardware components. Furthermore, as shown in FIG. 6, the hardware components having graphical representations overlaid by overlay components 602C-E may have full storage usage. A warning indicator, such as the exclamation point of graphical overlay 602E, may be included in the graphical overlay to indicate full storage of one or more hardware components. Such indicators may also be included in other overlays. The window 604 may present a user with additional information regarding the first RAID group, such as a name of the RAID group, a used RAID disk space of the first RAID group, an available RAID disk space of the first RAID group, one or more warnings about hardware components of the first RAID group. The window 604 may further include component characteristics of the hardware component the graphical representation of which was selected, such as a name of the hardware component, a status of the hardware component, a state of the hardware component, a slot of the hardware component, a write endurance of the hardware component, a protocol of the hardware component, a media type of the hardware component, and a size of the hardware component. In some embodiments, the hardware component view and the RAID group view may both be available when the information handling system is not in a passthrough mode, while only the hardware component view may be available when the information handling system is in a passthrough mode. In some embodiments, a RAID group may include multiple virtual disks, and further overlays may be generated when different virtual disks of a RAID group are selected. For example, if one or more virtual disks are selected by a user for display in a RAID group view, the graphical overlay components 602A-E may display storage usages, capacities, and wasted space for only the selected virtual disks on the respective hardware components that are members of the RAID group. Thus, if a RAID group includes two virtual disks and only a first virtual disk is selected, the first information handling system may calculate a storage usage for only the first virtual disk and may generate the graphical overlay of FIG. 6 for only the first virtual disk. In such an embodiment, the overlay components 602A-E may indicate the storage usage by the first virtual disk of the first RAID group, rather than the storage usage by all virtual disks of the first RAID group.

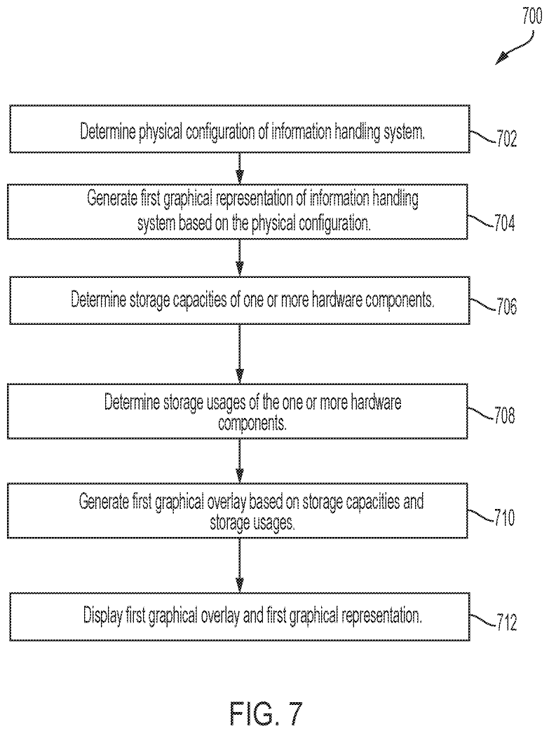

A first information handling system may perform a method 700 for generation and display of graphical representations and overlays for a physical configuration of a second information handling system as shown in FIG. 7. In some embodiments, the first information handling system and the second information handling system may be a same information handling system, while in other embodiments the first information handling system may be different from the second information handling system. The method 700 may begin, at block 702, with determination of a physical configuration of the second information handling system, such as a physical configuration of hardware components of the second information handling system. For example, the first information handling system may determine a form factor of one or more hardware components of the second information handling system, may determine information for slots of the second information handling system, such as a total number of slots and numbering of each of the slots, may determine hardware components located in the slots of the second information handling system, may determine a positioning or form factor of slots of the second information handling system, may determine a function of hardware components of the second information handling system, may determine slots of the second information handling system that are empty, may determine bays of the information handling system in which hardware components are located, or may determine other information related to a physical configuration of the second information handling system. Determination of the physical configuration of hardware components may be performed based on component characteristics of the hardware components. Determination of the physical configuration of the hardware components may include determining what hardware components are present in the second information handling system. For example, the first information handling system may perform back end discovery of hardware components and a physical configuration of hardware components to determine which specific hardware components are present in the second information handling system and where the specific hardware components are located in the second information handling system.

At block 704, the first information handling system may generate a graphical representation of the physical configuration of the second information handling system. For example, the graphical representation may show one or more slots of the second information handling system, one or more hardware components located in the one or more slots of the second information handling system, one or more empty slots of the second information handling system, form factors of slots of the second information handling system, form factors of hardware components of the second information handling system, numbers of slots of the second information handling system, and other physical configuration details of the second information handling system. In some embodiments, generating the graphical representation of the physical configuration of the second information handling system may include generating a first graphical representation of a physical configuration of hardware components located at a front of the second information handling system, generating a second graphical representation of a physical configuration of hardware components located at a back of the second information handling system, or generating other graphical representations of physical configurations of hardware components located on other faces of the second information handling system. In some embodiments, the first information handling system may reference known physical hardware, such as determined component characteristics of hardware components of the information handling system, against a pre-drawn database of information handling system hardware components to determine one or more graphical representations of hardware components. The first information handling system may then assemble a graphical representation of an information handling system including the multiple hardware components using pre-drawn graphical representations, such as scalable vector graphics representations, of hardware components that correspond to the hardware components determined to be present in the second information handling system. For example, the first information handling system may draw the hardware components based on a list of components determined to be present in the second information handling system, a physical configuration of the components, and one or more pre-drawn representations of individual hardware components. In some embodiments, the first information handling system may determine that a hardware change has occurred, such as removal or addition of a hardware component. When such a change is detected, the first information handling system may generate a graphical overlay reflecting the hardware change. For example, when such a change is detected the information handling system may repeat the operations described with respect to blocks 702 and 704.

At block 706, the first information handling system may determine storage capacities of one or more hardware components, and at block 708 the first information handling system may determine storage usages of the one or more hardware components. A storage capacity of a hardware component may be a total amount of storage of the hardware component, and a storage usage of the hardware component may be an amount of the storage capacity currently used to store data or currently allocated for data storage. Such determinations may be performed as parts of a determination of component characteristics of hardware components of the second information handling system. For example, storage usages and storage capacities of hardware components may be examples of component characteristics. Component characteristics may also include a form factor of a hardware component, a function of a hardware component, a slot of the second information handling system in which a hardware component is located, a RAID group to which a hardware component belongs, a hot spare status of a hardware component, a bay of the second information handling system in which a hardware component is located, a CXL capability of the hardware component, or other hardware component characteristics. Determination of such characteristics may be performed by querying one or more hardware components for component characteristics or by accessing such characteristics from memory of the information handling system. For example, the first information handling system may determine a first storage capacity of a first hardware component and a second storage capacity of a second hardware component. The first information handling system may also determine a first storage usage of the first hardware component and a second storage usage of the second hardware component. The first information handling system may also determine a first RAID group to which the first hardware component and the second hardware component belong. Such determinations may, for example, be made by querying a controller of the first hardware component for the first storage capacity, the first storage usage, and information about RAID group membership of the first hardware component and querying a controller of the second hardware component for the second storage capacity, the second storage usage, and information about RAID group membership of the second hardware component. As another example, the first information handling system may perform back-end discovery of hardware components and configuration of the hardware components to determine component characteristics of the hardware components. In some embodiments, an information handling system may perform the operations of blocks 706 and 708, and any of blocks 710 and 712, before or without performing the operations of blocks 702 and 704. In some embodiments, the information handling system may detect changes in hardware component characteristics, such as addition of new hardware components, removal of hardware components, changes in storage usage of hardware components, adjustments to configurations of hardware components, such as adjustments to RAID groups or hot spare statuses of hardware components, and the information handling system may adjust the graphical representation of the first information handling system or one or more graphical overlays based on the detected changes. Thus, the first information handling system may determine storage capacities and storage usages for one or more hardware components of the second information handling system.

At block 710, the first information handling system may generate a first graphical overlay for a graphical representation the physical configuration of the second information handling system based on the determined storage capacities and storage usages of one or more hardware components. For example, a first information handling system may generate a graphical overlay, as discussed with respect to FIGS. 4A-B, based on the determined storage capacity and storage usage. In some embodiments, one information handling system may generate the first graphical representation of the physical configuration of an information handling system, while another information handling system may generate one or more graphical overlays for the first graphical representation. In some embodiments, the first graphical overlay may include a first indication of a slot number of each of multiple slots of the second information handling system, such as when an option to show an enumeration of slots of the information handling system is selected. The first graphical overlay may, for example, include a first indication of a first storage usage of a first hardware component. The first graphical overlay may include a second indication of a second storage usage of a second hardware component. The first graphical overlay may include additional indications of additional storage usages of additional hardware components. In some embodiments, the first graphical overlay may include graphical indications of other component characteristics, such as bay location of hardware components, RAID groups of hardware components, or virtual disk allocations of hardware components.

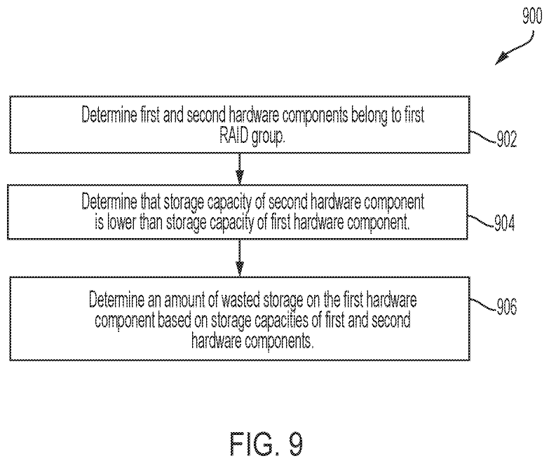

In some embodiments, the first graphical overlay may include additional indications, such as indications of wasted storage of one or more hardware components as described with respect to FIGS. 4A-B. For example, the method 900 of FIG. 9 may be performed along with the method 700 of FIG. 7, or other methods described herein, for generation of a graphical overlay that includes an indication of wasted storage on a first hardware component. The method 900 may, for example, begin at block 902 with determining that first and second hardware components belong to a first RAID group. For example, the second information handling system may determine RAID group membership, or lack thereof, for each hardware component represented in the graphical representation of a physical configuration of the second information handling system. Such a determination may, for example, be performed based on component characteristics of the first and second hardware components indicating that the first and second hardware components are members of a first RAID group. At block 904, the first information handling system may determine that storage capacity of the second hardware component is lower than storage capacity of the first hardware component. In some embodiments, such a determination may be a determination that the second hardware component has a lowest storage capacity of any hardware component in the first RAID group. For example, the first information handling system may compare storage capacities of hardware components that are determined at block 706 of FIG. 7. In some embodiments, such a comparison may be performed for all members of a first RAID group, to determine a lowest hardware component storage capacity of the first RAID group, for all members of a second RAID group, to determine a lowest hardware component storage capacity of the second RAID group, and for all members of other RAID groups, to determine lowest hardware component storage capacities of other RAID groups. At block 906, the first information handling system may determine an amount of wasted storage of the first hardware component based on the storage capacities of the first and second hardware components. For example, the amount of wasted storage of the first hardware component may be a difference between the storage capacity of the first hardware component and the storage capacity of the second hardware component. The first information handling system may make a similar determination for other members of the first RAID group, by determining differences between storage capacities of other members of the first RAID group and the storage capacity of the second hardware component when the second hardware component has a lowest storage capacity of any hardware component in the first RAID group, and for other members of other RAID groups, by determining differences between storage capacities of members of other RAID groups that do not have the lowest storage capacities in the respective RAID groups and storage capacities of members of the other RAID groups that do have the lowest storage capacities in the respective RAID groups. Thus, the first information handling system may determine amounts of wasted storage on multiple hardware components. Wasted storage may, for example, be unused storage that is not used and is not available for use based on a RAID group configuration. In some embodiments, generation of the first graphical overlay at block 710 of FIG. 7 may include generation of a third indication of the wasted storage of the first hardware component and generation of other indications of wasted storage of other hardware components, and such indications may be included in the first overlay.

At block 712, the first information handling system may display the first overlay and the first graphical representation. For example, the first information handling system may overlay the first graphical representation with the first overlay. Displaying the first overlay and the first graphical representation may include transmitting, by the first information handling system, the first overlay and the first graphical representation to a different information handling system for display on a display of the different information handling system. For example, the first information handling system may transmit display data for displaying the first graphical overlay and the first graphical representation to a third information handling system. As one example, the first information handling system may be a cloud-based server and the third information handling system may be a tablet, smart phone, or laptop. Displaying the first overlay and the first graphical representation may include displaying the first overlay and the first graphical representation on a display of the first information handling system. Thus, a first information handling system may generate a graphical representation of a physical configuration of a second information handling system and graphical overlays for the graphical representation based on component characteristics of the hardware components and may display the graphical representation and graphical overlays for a user.

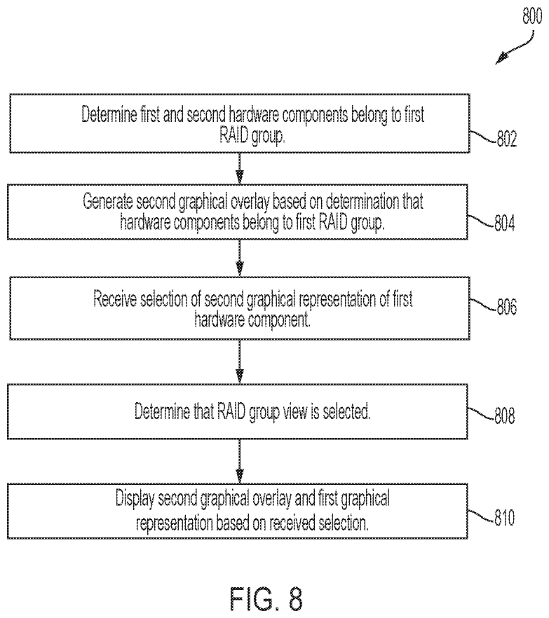

In some embodiments, a graphical user interface including the first graphical representation and the first graphical overlay may enable a user to interact with the first graphical representation or the first graphical overlay. An example method 800 for generation and display of an additional graphical overlay for a RAID group view is shown in FIG. 8. The method 800 may begin at block 802 with determining that first and second hardware components belong to a first RAID group. For example, the first information handling system may determine RAID group membership for multiple hardware components shown in the first graphical representation based on component characteristics, such as component characteristics indicating RAID group membership of the hardware components. In some embodiments, the method 800, and the method 900, may be performed only when the second information handling system is not in a passthrough mode, so that component characteristics related to RAID group membership may be determined. In some embodiments, the operations of block 802, and the operations of blocks 702, 706, and 708 may be performed as part of a hardware component characteristics determination operation.

At block 804, the first information handling system may generate a second graphical overlay based on the determination that the hardware components belong to a first RAID group. The second graphical overlay may, for example, include an indication of the first RAID group. The second graphical overlay may, in some embodiments, be a second graphical overlay as described with respect to FIG. 6. In some embodiments, the generation of the second graphical overlay may be performed prior to the operations described with respect to blocks 806 or 808. For example, the first information handling system may generate graphical overlays for multiple RAID groups in advance, based on a determination of multiple RAID groups of which hardware components shown in the graphical representation are members. In some embodiments, the generation of the second graphical overlay may be performed following the operations of block 806 or the operations of block 808. For example, the generation of the second graphical overlay at block 804 may be performed further based on receipt of a selection of a second graphical representation of the first hardware component or a determination that a RAID group view is selected.

At block 806, the first information handling system may receive a selection of a second graphical representation of a first hardware component. For example, a user may hover a cursor over a graphical representation of a hardware component of the second information handling system, may click on a graphical representation of a hardware component of the second information handling system, or may otherwise select a graphical representation of a hardware component of the second information handling system. The second graphical representation of the first hardware component may be a part of the first graphical representation of the physical configuration of the second information handling system.

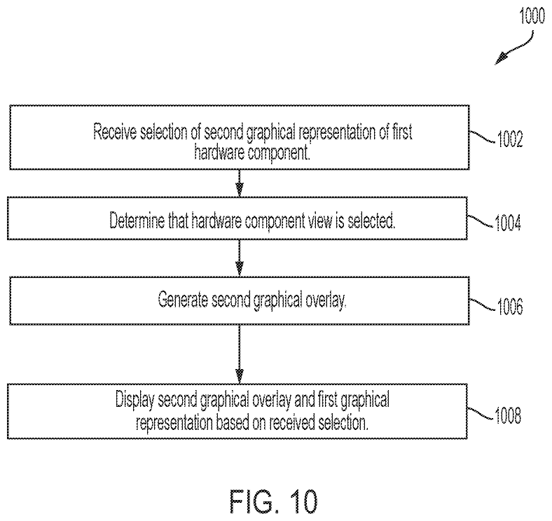

At block 808, the first information handling system may determine that a RAID group view is selected. For example, the graphical user interface may support multiple views such as a RAID group view and a hardware component view. The RAID group view may, for example, only be available if the second information handling system is not operating in a passthrough mode. If the hardware component view is selected, or if the second information handling system is operating in a passthrough mode, the first information handling system may perform the operations described with respect to blocks 1004-1008 of FIG. 10.

At block 810, the first information handling system may display the second graphical overlay and the first graphical representation based on the received selection. For example, the second graphical overlay and the first graphical representation may be displayed similarly to the display of the first graphical overlay and the first graphical representation described with respect to block 712 of FIG. 7.

As another example, a graphical user interface may allow a user to select and view a hardware component view. An example method 1000 for generation and display of an additional graphical overlay for a hardware component view is shown in FIG. 10. The method 1000 may begin at block 1002, with receipt of a selection of a second graphical representation of a first hardware component. For example, a user may hover a cursor over a graphical representation of a hardware component of the second information handling system, may click on a graphical representation of a hardware component of the second information handling system, or may otherwise select a graphical representation of a hardware component of the second information handling system. The second graphical representation of the first hardware component may be a part of the first graphical representation of the physical configuration of the second information handling system.

At block 1004, the first information handling system may determine that a hardware component view is selected. For example, the graphical user interface may support multiple views such as a RAID group view and a hardware component view. The RAID group view may, for example, only be available if the second information handling system is not operating in a passthrough mode. If a RAID group view is selected, the first information handling system may perform the operations described with respect to FIG. 8. In some embodiments, the operations described with respect to blocks 1006 and 1008 may be performed even if the hardware view is not selected, such as when the second information handling system is operating in the passthrough mode.

At block 1006, the first information handling system may generate a second graphical overlay. The second graphical overlay may, for example, include a second indication of one or more characteristics of the first hardware component. The second graphical overlay may, in some embodiments, be a second graphical overlay including a window as described with respect to FIG. 5. In some embodiments, the generation of the second graphical overlay may be performed prior to the operations described with respect to blocks 1002 or 1004. For example, the first information handling system may generate graphical overlays for multiple hardware components in advance, based on a determination of component characteristics of the hardware components. In some embodiments, the generation of the second graphical overlay may be performed following the operations of block 1002 or the operations of block 1004. For example, the generation of the second graphical overlay at block 1006 may be performed based on receipt of a selection of a second graphical representation of the first hardware component and a determination that a hardware component view is selected.

At block 1008, the first information handling system may display the second graphical overlay and the first graphical representation based on the received selection. For example, the second graphical overlay and the first graphical representation may be displayed similarly to the display of the first graphical overlay and the first graphical representation described with respect to block 712 of FIG. 7. In some embodiments, when the hardware component view is selected, hovering a cursor over a second graphical representation of a first hardware component may trigger display of the second graphical overlay described with respect to blocks 1006-1008, while clicking on the second graphical representation of the hardware component may cause a new page including details about the device to be displayed in place of or in addition to the graphical representations and overlays.

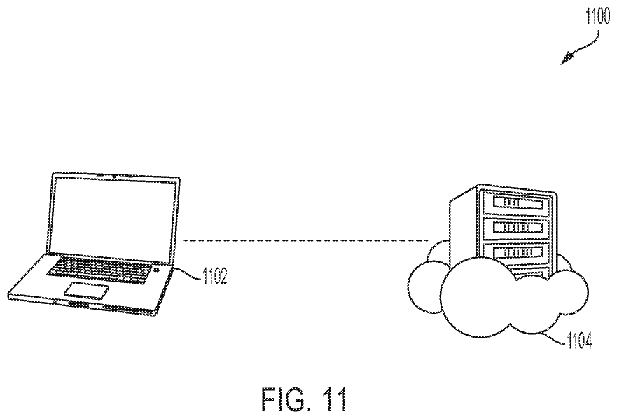

An example system 1100 for generation and display of a graphical representation of an information handling system 1104 and accompanying overlays is shown in FIG. 11. In some embodiments, an information handling system 1104 including the hardware components to be represented in the graphical representation may generate and display the graphical representations and overlays. For example, the information handling system 1104 may determine component characteristics by querying hardware components of the information handling system for component characteristics of hardware components of the information handling system 1104 and may generate graphical representations or overlays based on the component characteristics. In some embodiments, a different information handling system 1102, such as a remote connected information handling system, may generate or display the graphical representations and overlays discussed herein. For example, the information handling system 1102 may connect to the information handling system 1104 to receive component characteristics of hardware components of the information handling system 1104 for generation of graphical representations and overlays. The information handling system 1104 may generate graphical representations and overlays and may display such graphical representations and overlays on a display of the information handling system 1102. Alternatively or additionally, the information handling system 1104 may generate the graphical representations and overlays and may transmit the graphical representations and overlays to the information handling system 1102 for display on a display of the information handling system 1102. In such embodiments, displaying the graphical representations and overlays may be transmitting the graphical representations and overlays to the information handling system 1102 for display.

The flow chart diagrams of FIGS. 7-10 are generally set forth as logical flow chart diagrams. As such, the depicted order and labeled steps are indicative of aspects of the disclosed method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagram, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

If implemented in firmware and/or software, functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise random access memory (RAM), read-only memory (ROM), electrically-erasable programmable read-only memory (EEPROM), compact disc read-only memory (CD-ROM) or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and Blu-ray discs. Generally, disks reproduce data magnetically, and discs reproduce data optically. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

Although the present disclosure and certain representative advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A method, comprising:
determining a first storage capacity of a first hardware component of an information handling system;
determining a first storage usage of the first hardware component;
generating a first graphical overlay for a first graphical representation of a physical configuration of the information handling system based on the first storage capacity of the first hardware component and the first storage usage of the first hardware component, wherein the first graphical overlay comprises a first indication of the first storage usage of the first hardware component; and
displaying the first graphical overlay and the first graphical representation.

2. The method of claim 1, further comprising:
determining a second storage capacity of a second hardware component of the information handling system; and
determining a second storage usage of the second hardware component,
wherein the first graphical overlay is generated further based on the second storage capacity of the second hardware component and the second storage usage of the second hardware component, and
wherein the first graphical overlay comprises a second indication of the second storage usage of the second hardware component.

3. The method of claim 2, further comprising:
determining that the first hardware component and the second hardware component belong to a first redundant array of independent disks (RAID) group; and
generating a second graphical overlay for the first graphical representation based on the determination that the first hardware component and the second hardware component belong to the first RAID group, wherein the second graphical overlay comprises a third indication of the first RAID group.

4. The method of claim 3, further comprising:
receiving a selection of a second graphical representation of the first hardware component, wherein the first graphical representation comprises the second graphical representation;
determining that a RAID group view is selected; and
displaying the second graphical overlay and the first graphical representation based on the received selection.

5. The method of claim 2, further comprising:
determining that the first hardware component and the second hardware component belong to a first RAID group;
determining that the second storage capacity of the second hardware component is lower than the first storage capacity of the first hardware component; and
determining an amount of wasted storage of the first hardware component based on the second storage capacity of the second hardware component and the first storage capacity of the first hardware component,
wherein generating the first graphical overlay further comprises generating a third indication of the wasted storage of the first hardware component, and
wherein the first graphical overlay comprises the third indication.

6. The method of claim 1, further comprising:
determining the physical configuration of the information handling system; and
generating the first graphical representation of the physical configuration of the information handling system based on the determined physical configuration.

7. The method of claim 1, further comprising:
receiving a selection of a second graphical representation of the first hardware component, wherein the first graphical representation comprises the second graphical representation;
determining that a hardware component view is selected;
generating a second graphical overlay for the first graphical representation, wherein the second graphical overlay comprises a second indication of one or more characteristics of the first hardware component; and
displaying the second graphical overlay and the first graphical representation based on the received selection.

8. A first information handling system, comprising:
a memory; and
at least one processor coupled to the memory, wherein the at least one processor is configured to:
determine a first storage capacity of a first hardware component of a second information handling system;
determine a first storage usage of the first hardware component;
generate a first graphical overlay for a first graphical representation of a physical configuration of the first information handling system based on the first storage capacity of the first hardware component and the first storage usage of the first hardware component, wherein the first graphical overlay comprises a first indication of the first storage usage of the first hardware component; and
display the first graphical overlay and the first graphical representation.

9. The first information handling system of claim 8, wherein the at least one processor is further configured to:
determine a second storage capacity of a second hardware component of the first information handling system; and
determine a second storage usage of the second hardware component,
wherein the first graphical overlay is generated further based on the second storage capacity of the second hardware component and the second storage usage of the second hardware component, and
wherein the first graphical overlay comprises a second indication of the second storage usage of the second hardware component.

10. The first information handling system of claim 9, wherein the at least one processor is further configured to:
determine that the first hardware component and the second hardware component belong to a first redundant array of independent disks (RAID) group; and
generate a second graphical overlay for the first graphical representation based on the determination that the first hardware component and the second hardware component belong to the first RAID group, wherein the second graphical overlay comprises a third indication of the first RAID group.

11. The first information handling system of claim 10, wherein the at least one processor is further configured to:
receive a selection of a second graphical representation of the first hardware component, wherein the first graphical representation comprises the second graphical representation;
determine that a RAID group view is selected; and
display the second graphical overlay and the first graphical representation based on the received selection.

12. The first information handling system of claim 9, wherein the at least one processor is further configured to:
determine that the first hardware component and the second hardware component belong to a first RAID group;
determine that the second storage capacity of the second hardware component is lower than the first storage capacity of the first hardware component; and
determine an amount of wasted storage of the first hardware component based on the second storage capacity of the second hardware component and the first storage capacity of the first hardware component,
wherein the at least one processor is further configured to generate a third indication of the wasted storage of the first hardware component to generate the first graphical overlay, and
wherein the first graphical overlay comprises the third indication.

13. The first information handling system of claim 8, wherein the at least one processor is further configured to:
determine the physical configuration of the first information handling system; and
generate the first graphical representation of the physical configuration of the first information handling system based on the determined physical configuration.

14. The first information handling system of claim 8, wherein the at least one processor is further configured to:
receive a selection of a second graphical representation of the first hardware component, wherein the first graphical representation comprises the second graphical representation;
determine that a hardware component view is selected;
generate a second graphical overlay for the first graphical representation, wherein the second graphical overlay comprises a second indication of one or more characteristics of the first hardware component; and
display the second graphical overlay and the first graphical representation based on the received selection.

15. A computer program product, comprising:
a non-transitory computer readable medium comprising instructions for causing a first information handling system to perform steps comprising:
determining a first storage capacity of a first hardware component of a second information handling system;
determining a first storage usage of the first hardware component;
generating a first graphical overlay for a first graphical representation of a physical configuration of the second information handling system based on the first storage capacity of the first hardware component and the first storage usage of the first hardware component, wherein the first graphical overlay comprises a first indication of the first storage usage of the first hardware component; and
displaying the first graphical overlay and the first graphical representation.

16. The computer program product of claim 15, wherein the non-transitory computer readable medium further comprises instructions for causing a first information handling system to perform steps comprising:
determining a second storage capacity of a second hardware component of the second information handling system; and
determining a second storage usage of the second hardware component,
wherein the first graphical overlay is generated further based on the second storage capacity of the second hardware component and the second storage usage of the second hardware component, and
wherein the first graphical overlay comprises a second indication of the second storage usage of the second hardware component.

17. The computer program product of claim 16, wherein the non-transitory computer readable medium further comprises instructions for causing a first information handling system to perform steps comprising:
determining that the first hardware component and the second hardware component belong to a first redundant array of independent disks (RAID) group; and
generating a second graphical overlay for the first graphical representation based on the determination that the first hardware component and the second hardware component belong to the first RAID group, wherein the second graphical overlay comprises a third indication of the first RAID group.

18. The computer program product of claim 17, wherein the non-transitory computer readable medium further comprises instructions for causing a first information handling system to perform steps comprising:
receiving a selection of a second graphical representation of the first hardware component, wherein the first graphical representation comprises the second graphical representation;
determining that a RAID group view is selected; and
displaying the second graphical overlay and the first graphical representation based on the received selection.

19. The computer program product of claim 16, wherein the non-transitory computer readable medium further comprises instructions for causing a first information handling system to perform steps comprising:
determining that the first hardware component and the second hardware component belong to a first RAID group;
determining that the second storage capacity of the second hardware component is lower than the first storage capacity of the first hardware component; and
determining an amount of wasted storage of the first hardware component based on the second storage capacity of the second hardware component and the first storage capacity of the first hardware component,
wherein generating the first graphical overlay further comprises generating a third indication of the wasted storage of the first hardware component, and
wherein the first graphical overlay comprises the third indication.

20. The computer program product of claim 15, wherein the non-transitory computer readable medium further comprises instructions for causing a first information handling system to perform steps comprising:
determining the physical configuration of the second information handling system; and
generating the first graphical representation of the physical configuration of the second information handling system based on the determined physical configuration.
